(19) United States
(12) Patent Application Publication
(10) Pub. No.: US 2006/0082928 A1
(43) Pub. Date: Apr. 20, 2006

(54) Disk device

(75) Inventors: Kan Takahashi, Tokyo (JP); Kazuhiro Yoshida, Akishima-shi (JP); Mitsunobu Hanyu, Hamura-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/251,800

(22) Filed: Oct. 18, 2005

(30) Foreign Application Priority Data
Oct. 20, 2004 (JP) 2004-306082

(51) Int. Cl. G11B 5/60

(52) U.S. Cl. 360/235.8

(57) ABSTRACT

A slider of a head has a negative-pressure cavity formed in a facing surface, a leading step portion and a leading pad which protrude from the facing surface and are situated on the upstream side of the negative-pressure cavity with respect to an airflow, and a trailing step portion and a trailing pad which protrude from the facing surface and are situated on the downstream side of the negative-pressure cavity with respect to the airflow. The surface area of the trailing pad accounts for 1.5% or more of the area of the disk facing surface of the slider, and at least the surface of the trailing pad is microtexured. The surface roughness of a recording medium that faces the slider is 0.8 nm or less in terms of Ra, and the head suspension applies a head load of 1 gf or more to the head.

### CROSS-REFERENCE TO RELATED APPLICATIONS

This application is based upon and claims the benefit of priority from prior Japanese Patent Application No. 2004-306082, filed Oct. 20, 2004, the entire contents of which are incorporated herein by reference.

### BACKGROUND OF THE INVENTION

1. Field of the Invention

This invention relates to a disk device provided with a disk-shaped recording medium with a diameter of an inch or less.

2. Description of the Related Art

A magnetic disk device as a typical disk device comprises magnetic disks contained in a case, a spindle motor that supports and rotates the disks, magnetic heads for reading and writing information from and to the disks, and a carriage assembly that supports the heads for movement with respect to the disks. The carriage assembly is provided with rockably supported arms and suspensions that extend from the arms. The magnetic heads are supported individually on the respective extended ends of the suspensions. Each magnetic head has a slider mounted on its corresponding suspension and a head portion on the slider. The head portion includes a reproducing element and a recording element that are used to read and write information.

The slider has a facing surface that faces a recording surface of the magnetic disk. The slider is subjected by the suspension to a given head load that is directed toward a magnetic recording layer of the magnetic disk. When the magnetic disk device is actuated, an airflow is produced between the rotating disk and the slider. Based on the surface effect principle of aerodynamics, a force to fly the slider above the recording surface of the disk acts on the facing surface of the slider. By balancing this flying force and the head load, the slider can be flown with a given gap above the recording surface of the magnetic disk.

The flying height of the slider is found to be substantially uniform without regard to the radial position on the magnetic disk. The rotational frequency of the disk is fixed, and its line speed varies depending on the radial position. Since the magnetic head is positioned by a rotary carriage assembly, moreover, the skew angle (angle between the direction of the airflow and the center line of the slider) also varies depending on the radial position on the disk. In designing the slider, therefore, change of the flying height that depends on the radial disk position must be restrained by suitably utilizing the aforesaid two parameters that vary depending on the radial disk position.

In consideration of the change of the working environment, the disk device is expected to operate smoothly in a low-pressure highland environment. If the magnetic head is constructed in consideration of only the balance between the head load and a positive pressure that acts on the facing surface of the slider based on the air fluid lubrication, the positive pressure that is generated by the air fluid lubrication is lowered in the low-pressure environment. Inevitably, therefore, the slider is balanced in a position where the flying height is reduced or the head touches the magnetic disk surface.

Described in Jpn. Pat. Appln. KOKAI Publication No. 2001-283549, for example, is a disk device in which a negative-pressure cavity is formed near the center of a facing surface of a slider in order to prevent a reduction of the flying height. The negative-pressure cavity is defined by a groove that is surrounded by projected rails in three other directions than an air outlet direction. The slider is configured to fly on the balance between a negative pressure generated by the negative-pressure cavity, a head load, and a positive pressure. In a low-pressure environment, according to this configuration, the negative pressure is also reduced as the generated positive pressure is reduced. Thus, the slider can be realized having less reduction in flying height. A center pad is formed in the negative-pressure cavity on the air outlet end side of the slider. A head portion is formed on the outlet side end face of the slider so as to be situated near the center pad. Thus, the flying height, flying posture, and flying height reduction under decompression of the slider can be adjusted by suitably arranging an irregular shape of the facing surface of the slider.

Modern magnetic disks have been reduced in diameter with the progress of miniaturization of magnetic disk devices. While 3.5- and 2.5-inch magnetic disk devices have prevailed so far, 1.8-, 1.0-, and 0.85-inch disk devices are already commercialized or scheduled to be commercialized. Taking advantage of their smallness, these magnetic disk devices are mounted mainly in mobile equipment.

For a head slider of these small-diameter magnetic disk devices, on the other hand, the line speed of disks are lowered as the disk diameter is reduced, and an air bearing force that supports the slider is lessened. It is difficult, therefore, to ensure various characteristics required of the slider, such as the line speed dependence of the flying height, flying height reduction under decompression, etc., while supporting a desired head pressing load. This head pressing load is settled mainly depending on impact resistance, and the mobile application requires a higher impact resistance. Thus, the head pressing load cannot be blindly reduced even in the small-diameter magnetic disk devices.

The behavior under decompression is one of essential characteristics that are required of the slider. The behavior under decompression is a vibration of the slider caused when the flying height under decompressed conditions is reduced so that the slider touches a disk. Under the decompressed conditions, the slider may possibly touch the magnetic disk, owing to combined reductions in flying height that are attributable to a seek and variation in manufacture. In order to manufacture a high-reliability magnetic disk device, therefore, the slider vibration under decompression must be minimized.

### BRIEF SUMMARY OF THE INVENTION

According to an aspect of the invention, a disk device comprises: a disk-shaped recording medium with a surface roughness of 0.8 nm or less in terms of Ra and a diameter of 1 inch or less; a drive unit which supports and rotates the recording medium; a head provided with a slider which has a facing surface opposed to a surface of the recording medium and is aerodynamically supported by an airflow generated between the recording medium surface and the facing surface as the recording medium rotates and a head portion which is provided on the slider and records and reproduces information to and from the recording medium; and a head suspension which supports the head for movement with respect to the recording medium and applies to the head a head load of 1 gf or more directed toward the surface of the recording medium.

The slider has a negative-pressure cavity which is defined by a recess formed in the facing surface and generates a negative pressure, a leading step portion and a leading pad which protrude from the facing surface, are situated on the upstream side of the negative-pressure cavity with respect to the airflow, and face the recording medium, and a trailing step portion and a trailing pad which protrude from the facing surface, are situated on the downstream side of the negative-pressure cavity with respect to the airflow, and face the recording medium, the surface area of the trailing pad accounting for 1.5% or more of the area of the disk facing surface of the slider, and at least the surface of the trailing pad being microtexured.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing a hard disk drive (hereinafter, referred to as an HDD) according to an embodiment of the invention;

FIG. 2 is an enlarged side view showing a magnetic head portion of the HDD;

FIG. 3 is a perspective view showing the disk facing surface side of a slider of the magnetic head;

FIG. 4 is a plan view showing the disk facing surface side of the slider;

FIG. 5 is a diagram showing the relationship between radial positions and line speeds of disks with different diameters;

FIG. 6 is a view schematically showing a state in which the slider of the magnetic head and a surface of a magnetic disk are in contact with each other;

FIG. 7 is an enlarged view schematically showing a contact portion be the slider of the magnetic head and the magnetic disk surface;

FIG. 8 is an enlarged view showing a part of the microtextured slider;

FIG. 9 is a sectional view showing a part of the slider shown in FIG. 8; and

FIGS. 10A and 10B are diagrams showing the relationship between microtexture depths and bearing regions.

### DETAILED DESCRIPTION OF THE INVENTION

An embodiment in which a disk device according to this invention is applied to an HDD will now be described in detail with reference to the accompanying drawings.

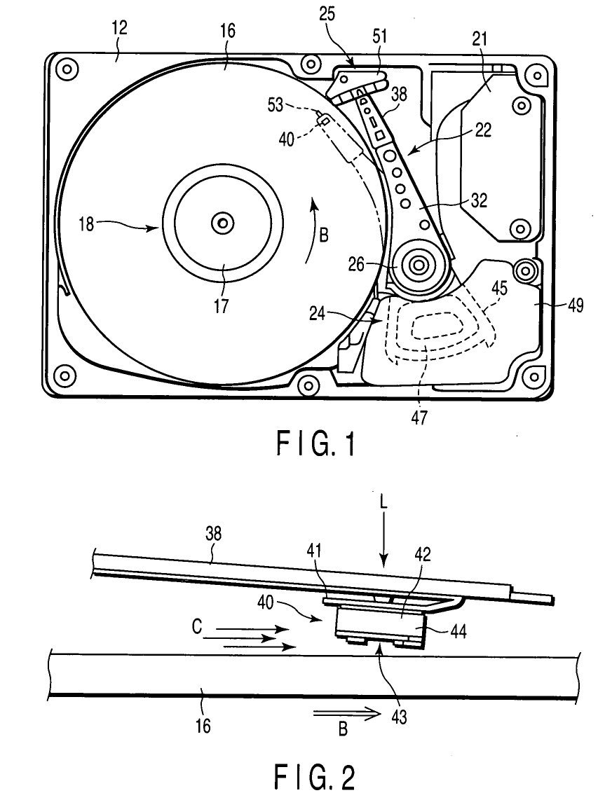

As shown in FIG. 1, the HDD comprises a case 12 in the form of an open-topped rectangular box and a top cover (not shown). The top cover is screwed to the case with screws and closes a top opening of the case.

The case 12 contains a magnetic disk 16 for use as a recording medium, a spindle motor 18, magnetic heads, and a carriage assembly 22. The spindle motor 18 serves as a drive unit that supports and rotates the disk. The magnetic heads are used to write and read information on and from the disk. The carriage assembly 22 supports the magnetic heads for movement with respect to the magnetic disk 16. The case 12 further contains a voice coil motor (VCM) 24, a ramp load mechanism 25, a board unit 21, etc. The VCM 24 rocks and positions the carriage assembly. The ramp load mechanism 25 holds the magnetic heads in a shunt position off the magnetic disk when the heads are moved to the outermost periphery of the disk. The board unit 21 has a head IC and the like.

A printed circuit board (not shown) is screwed to the outer surface of a bottom wall of the case 12. This circuit board controls the respective operations of the spindle motor 18, VCM 24, and magnetic heads through the board unit 21.

The magnetic disk 16 has magnetic recording layers on its upper and lower surfaces, individually. The surfaces of the magnetic disk 16 are surface roughness of 0.8 or less in terms of Ra. The diameter of the magnetic disk 16 is 1 inch or less, for example 0.85 inch. The disk 16 is fitted on the outer periphery of a hub (not shown) of the spindle motor 18 and fixed on the hub by a clamp spring 17. As the motor 18 is driven, the disk 16 is rotated at a given speed of, e.g., 4,200 rpm, in the direction of arrow B.

The carriage assembly 22 comprises a bearing assembly 26 fixed on the bottom wall of the case 12 and arms 32 that extend from the bearing assembly. These arms 32 are situated parallel to the surface of the magnetic disk 16 and spaced from one another. They extend in the same direction from the bearing assembly 26. The carriage assembly 22 is provided with suspensions 38 that are formed of an elastically deformable elongated plate spring each. The suspensions 38 have their respective proximal ends fixed to the respective distal ends of the arms 32 by spot welding or adhesive bonding and extend from the arms. Each suspension 38 may be formed integrally with its corresponding arm 32. The arms 32 and the suspensions 38 constitute a head suspension. The head suspension and the magnetic heads constitute a head suspension assembly.

As shown in FIG. 2, each magnetic head 40 has a substantially rectangular slider 42 and a head portion 44 for recording and reproduction on the slider. It is fixed to a gimbals spring 41 that is provided on the distal end portion of the suspension 38. A head load L that is directed toward the surface of the magnetic disk 16 is applied to each magnetic head 40 by the elasticity of the suspension 38. As described later, the head load L is set to be 1 gf or more.

As shown in FIG. 1, the carriage assembly 22 has a support frame 45 that extends from the bearing assembly 26 in a direction opposite from the arms 32. This support frame supports a voice coil 47 that constitutes a part of the VCM 24. The support frame 45 is molded integrally from synthetic resin on the outer periphery of the coil 47. The voice coil 47 is situated between a pair of yokes 49 that are fixed on the case 12. The coil 47, along with the yokes and a magnet (not shown) fixed to one of the yokes, constitutes the VCM 24. If the voice coil 47 is energized, the carriage assembly 22 rocks around the bearing assembly 26, and the magnetic head 40 is moved to and positioned over a desired track of the magnetic disk 16.

The ramp load mechanism 25 comprises a ramp 51 and a tab 53. The ramp 51 is provided on the bottom wall of the case 12 and located outside the magnetic disk 16. The tab 53 extends from the distal end of each suspension 38. As the carriage assembly 22 rocks to a shunt position outside the magnetic disk 16, each tab 53 engages a ramp surface formed on the ramp 51. Thereafter, the tab 53 is pulled up by the inclination of the ramp surface, whereby the magnetic head is unloaded.

The following is a detailed description of the magnetic head 40. As shown in FIGS. 2 to 4, the magnetic head 40 has the slider 42 substantially in the shape of a rectangular parallelepiped. The slider has a rectangular disk facing surface 43 that faces the surface of the magnetic disk 16. The longitudinal direction of the disk facing surface 43 is defined as a first direction X, and the transverse direction perpendicular to it as a second direction Y.

The magnetic head 40 is constructed as a flying slider. As the magnetic disk 16 rotates, the slider 42 is aerodynamically supported by an airflow (air bearing force) C that is generated between the disk surface and the disk facing surface 43. When the HDD is operating, the disk facing surface 43 of the slider 42 never fails to face the disk surface with a gap between them. The direction of the airflow C is coincident with the rotation direction B of the magnetic disk 16. The slider 42 is located with respect to the surface of the disk 16 so that the first direction X of the disk facing surface 43 is substantially coincident with the direction of the airflow C.

A leading step portion 50 protrudes from the disk facing surface 43 so as to face the magnetic disk surface. The step portion 50 is closed on the upstream side with respect to the direction of the airflow C and has a substantially U-shaped shape opening on the downstream side. In order to maintain a pitch angle of the magnetic head 40, a leading pad 52 for supporting the slider 42 by an air bearing protrudes from the leading step portion 50. The leading pad 52 has an elongated shape continuously extending along the second direction Y and is situated on the inlet end side of the slider 42 with respect to the airflow C.

The leading step portion 50 has a pair of rail portions 46 that extend along the long sides of the disk facing surface 43 and are spaced and opposed to each other. Each rail portion 46 extends from the leading pad 52 to the downstream end side of the slider 42. A side pad 48 is formed on each rail portion 46 and faces the magnetic disk surface.

Formed substantially in the central part of the disk facing surface 43 is a negative-pressure cavity 54, a recess that is defined by the rail portions 46 and the leading step portion 50. The negative-pressure cavity 54 is formed on the downstream side of the leading step portion 50 with respect to the direction of the airflow C and opens on the downstream side. With the presence of the negative-pressure cavity 54, a negative pressure can be generated in the central part of the disk facing surface 43, covering all skew angles that are realized in the HDD.

The slider 42 has a trailing step portion 56 that protrudes from the downstream-side end portion of the disk facing surface 43 and faces the magnetic disk surface. The trailing step portion 56 is situated on the downstream side of the negative-pressure cavity 54 with respect to the direction of the airflow C and substantially in the center of the disk facing surface 43 with respect to the transverse direction.

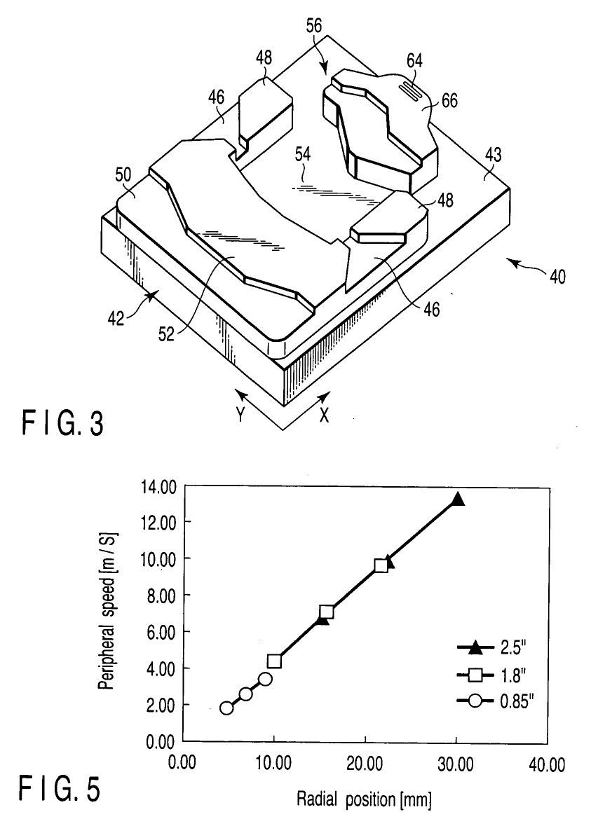

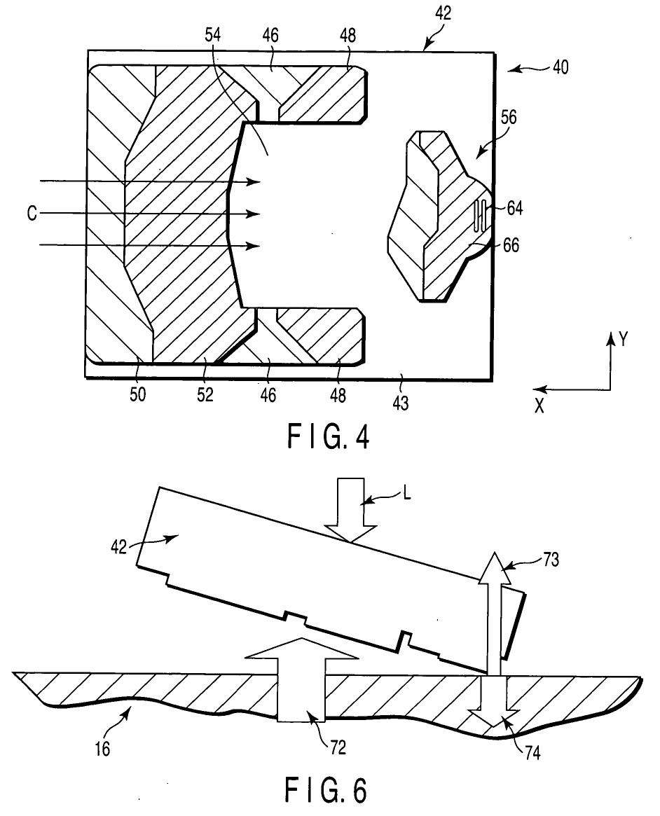

As shown in FIGS. 3 and 4, the trailing step portion 56 is in the form of a substantially rectangular block and provided on the outlet end side of the disk facing surface 43. The upper surface of the trailing step portion 56 faces the surface of the magnetic disk 16. A trailing pad 66 is formed on the downstream-side end portion the upper surface of the trailing step portion, and it faces the surface of the disk 16.

As shown in FIGS. 2 to 4, the head portion 44 of the magnetic head 40 has a recording element and a reproducing element for recording and reproducing information to and from the magnetic disk 16. The recording and reproducing elements are embedded in the downstream-side end portion of the slider 42 with respect to the direction of the airflow C. They have read/write gaps 64 formed in the trailing pad 66.

As shown in FIG. 2, the magnetic head 40 with this configuration flies in a tilted posture such that the read/write gaps 64 of the head portion 44 are situated closest to the disk surface.

In the slider constructed in this manner, the area of the upper surface of the trailing pad 66 ranges from 1.5% or more of the general surface area of the disk facing surface 43, and preferably from 2 to 5%. As described later, moreover, at least the upper surface of the trailing pad 66, i.e., the entire surface of the disk facing surface 43 in the present embodiment, is microtextured to a microtexture depth of 1 nm or more.

In the HDD constructed in this manner, the behavior under decompression is one of essential characteristics that are required of the slider 42. The behavior under decompression is vibration of the slider caused when the flying height under decompressed conditions is reduced so that the slider touches the disk. Under the decompressed conditions, the slider 42 may possibly touch the magnetic disk 16, owing to combined reductions in flying height that are attributable to a seek and variation in manufacture. In order to manufacture a high-reliability magnetic disk device, therefore, the slider vibration under decompression must be minimized.

A touchdown/takeoff (TD/TO) test is a modern method that is most frequently used to evaluate the slider behavior under decompression. In this test, the slider vibration is observed by using an acoustic emission (AE) sensor or a laser Doppler vibrometer with the head loaded on the magnetic disk as the pressure is reduced. The atmospheric pressure is read when the slider engages the magnetic disk and vibrates heavily (touchdown mode). In this state, the pressure is gradually increased as the vibration is observed. The atmospheric pressure is read when the slider ceases to engage the magnetic disk and stops vibration (takeoff mode). The susceptibility to vibration is evaluated according to the size of an atmospheric pressure difference (TO−TD) obtained by subtracting the touchdown atmospheric pressure from the takeoff atmospheric pressure. Since vibration stops soon if this atmospheric pressure difference is small, the slider can be regarded as a high-characteristic slider that vibrates little under decompression. Hereinafter, the aspect of the vibration under decompression will be referred to as the decompression characteristic, and a slider with a small atmospheric pressure difference will be described as having a good decompression characteristic.

FIG. 5 shows the respective line speeds of HDDs with three disk diameters, and Table 1 shows results of a typical TD/TO test. The TD/TO characteristics varies depending on the ABS pattern and pitching and rolling angles of the slider 42, crown and camber shapes, media surface roughness, etc. However, the results shown in Table 1 represent typical examples of heads that are mounted in the HDDs with those disk diameters, and magnetic disks have the same surface roughness. Accordingly, these characteristics may be regarded as common ones.

TABLE 1

| | 2.5 | 1.8 | 0.85 |
|---|---|---|---|
| | inches | inches | inches |
| Touchdown (atm) | 0.52 | 0.53 | 0.55 |
| Takeoff (atm) | 0.68 | 0.69 | 0.95 |
| TO − TD (atm) | 0.16 | 0.16 | 0.40 |

Small-diameter disks described in connection with the present embodiment are disks of 1 inch or less. In the following, 0.85-inch disks will be described as typical examples of the disks of the present embodiment. Table 1 indicates that the disks of 0.85-inch are much greater in atmospheric pressure difference (TO−TD) and poorer in decompression characteristic than 2.5- and 1.8-inch disks, although the TD atmospheric pressures of these disks have no substantial difference. This is supposed to be attributable to the fact that the line speed of each magnetic disk is so low that the air bearing is not rigid enough for a 0.8-inch slider that is supported by a low air bearing pressure. As seen from FIG. 5, this low line speed condition is a special condition such that the line speeds of 0.85-inch disks are much lower than the outer line speeds of 1.8-inch disks and the inner line speeds of 2.5-inch disks, which overlap one another.

A touchdown-takeoff phenomenon is a phenomenon that the flying height is recovered by pressurization after the slider 42 has started engaging the magnetic disk and vibrating, whereby the frequency of collision between the slider 42 and the magnetic disk is lowered, and takeoff is finally performed. Thus, for the lower frequency of collision between the slider and the magnetic disk, the slider should preferably be one that cannot easily vibrate or has high rigidity.

When the slider 42 and the magnetic disk are in contact with each other, three forces, (1) an air bearing force, (2) a disk reaction force, and (3) an attraction force attributable to a lubricant on the disk surface, act on the slider 42. The attraction force (3) is a force to attract the slider to the disk. If it is too large, the slider easily adheres to the disk, so that slider cannot readily cease to vibrate. In order to improve the decompression characteristic, therefore, it is important to reduce the attraction force between the slider and the disk.

On the other hand, a head load that presses the slider 42 against the magnetic disk is also an important factor. In general, a magnetic disk device for a small-diameter disk is used for a mobile application, such as a cell phone. When compared with other large-diameter disk device, therefore, it requires higher anti-shock performance. In order to enhance the anti-shock performance of the magnetic disk device in operation, it is essential to increase the head load.

Table 2 shows results of anti-shock simulation and partial observation obtained when the slider ABS (air bearing surface) pattern and head load were changed in a 0.85-inch magnetic disk drive, a typical example for a small-diameter magnetic disk. A condition that determines the anti-shock performance in the simulation is that the slider 42 and the magnetic disk should not collide with each other. Further, the ABS pattern of the slider 42 used for the simulation, which represents approximate performance, is not optimized, since 1- and 1.5-gf were fabricated by slightly modifying a slider for a head load of 2 gf for simplicity. Based on the result of a 2 gf condition, moreover, there is a difference of about 50 G between the simulation and the observation.

TABLE 2

| | 1 gf | 1.5 gf | 2 gf |
|---|---|---|---|
| Simulation | 950 G | 1000 G | 1200 G |
| Measured value | | | 1250 G |

In order to secure a fall impact acceleration of 1,000 G that is required by the magnetic disk device for mobile use, as seen from Table 2, a head load of about 1 gf or more is needed in consideration of the fact that the difference between the simulation and the observation and the ABS pattern are not optimized. Thus, in the small-diameter magnetic disk device, the head load of 1 gf or more is an essential requirement. In the description to follow, therefore, all head loads will be supposed to be 1 gf or more unless otherwise stated.

If the mechanism of the aforesaid touchdown-takeoff phenomenon is taken into consideration, the generated pressure of the air bearing, i.e., the air bearing rigidity, is so low in a special line speed condition for the 0.85-inch magnetic disk drive that the decompression characteristic is naturally poor. In order to realize the necessary anti-shock performance for the small-diameter disk device, moreover, it is essential that the head load should be 1 gf or more. In the present embodiment, therefore, the decompression characteristic is improved in the slider for the small-diameter magnetic disk with a low line speed, low rigidity, and head load of 1 gf or more.

In the slider of the small-diameter magnetic disk device, as mentioned before, the air bearing rigidity is inevitably reduced, so that the decompression characteristic is poor. However, this reduction of the rigidity is unavoidable because of the small diameter. Although the rigidity may possibly be enhanced by shaping the pattern of the disk facing surface 43 of the slider 42, it cannot be expected very much. As seen from Table 1, moreover, the decompression characteristic of the small-diameter magnetic disk of about 0.85-inch diameter worsens considerably, so that a high-reliability slider cannot be provided without improvement. Accordingly, a configuration may be devised to reduce the attraction force between the slider 42 and the magnetic disk, another factor that determines the decompression characteristic.

FIG. 6 schematically shows a state in which the slider 42 and the magnetic disk 16 are in contact with each other at the trailing edge of the slider 42. When the slider 42 and the magnetic disk 16 are in contact, as mentioned before, the slider is subjected to four forces, a head load L, an air bearing force 72, a disk reaction force 73, and an attraction force 74.

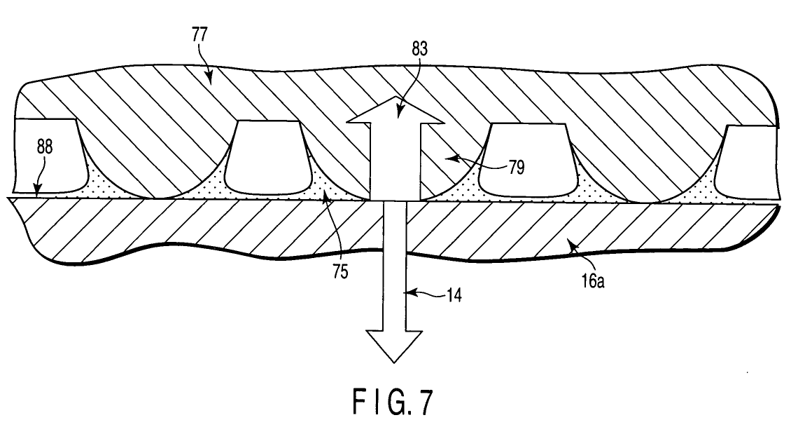

FIG. 7 microscopically shows the disk reaction force 73 and the attraction force 74 for surface asperities of the one slider 42. In this drawing, a slider surface 77 and a disk surface 16a are both rough. The disk surface is an ideal flat surface. The slider surface has a uniform asperity radius and asperity height representative of an equivalent roughness that depends on the slider surface and the disk surface.

When the slider 42 is in contact with the surface 16a of the magnetic disk 16, the disk surface 16a collapses asperities 79 on the slider surface 77, so that an asperity reaction force 83 is generated at this portion. The asperity reaction force for the entire contact area is represented the product of the reaction forces of the individual asperities, an asperity density and an apparent contact area.

Since the magnetic disk surface 16a is coated with a lubricant 88, on the other hand, menisci 75 are formed around the asperities 79, so that the attraction force 74 is generated. Although the menisci in this case are in a toe-dipping state, they may alternatively be in a pillbox state. The attraction force 74 for the entire contact area of the slider is represented by the product of the attraction forces of the asperities 79, an asperity density, and the apparent contact.

An attraction force Fm of each asperity 79 is given by the following equation in the toe-dipping state:
Fm=2πRγ(1+cos θ)N₀(h₀, A, D),
where R is an asperity radius, γ is a contact angle, and N₀(h₀, A, D) is the number of asperities (lubricant thickness h₀, contact area A, asperity density function D).

In order to lessen the attraction force Fm, therefore, (1) the thickness of the lubricant on the magnetic disk is reduced, (2) the asperity densities of the magnetic disk and the slider are lowered, or (3) the contact area of the slider is reduced. If the thickness of the lubricant is reduced, however, its coverage becomes so poor that the disk surface cannot be covered entirely. The asperity density of the magnetic disk surface is inevitably determined depending on the disk material and manufacturing method. Among modern high-recording-density magnetic disks, those disks which have low asperity density and height are favorable for the improvement of the quality of write/read signals. This requirement is contradictory to the reduction of the attraction force.

According to the present embodiment, therefore, the contact area of the slider 42 is reduced. Reducing the area of that part of an ABS surface that touches the magnetic disk 16 is one method of reducing the contact area of the slider 42. As shown in FIG. 4, that part of the slider 42 which easily touches the magnetic disk, that is, the downstream-end-side edge of the trailing pad 66, has a pitching angle, so that the flying height is the lowest at that part. Further, the downstream-side end of each rail portion 46 is a place that can be the lowest flying point when the slider 42 rolls. Thereupon, the areas of the downstream-end-side edge of the trailing pad 66 and the downstream-side end of the rail portion 46 are lessened to reduce the area of contact with the magnetic disk. Since these places are also parts where high pressures are generated, however, the air bearing force that supports the slider 42 inevitably lowers if the areas are lessened. If the pressure of the trailing edge lowers, the flying height lowers inevitably. If the pressure of the rail portion 46 lowers, the rigidity in the rolling direction is reduced and destabilized.

In a head slider for a small-diameter magnetic disk of which the line speed and the air bearing pressure are low with the head load of 1 gf or more that fulfills the anti-shock performance, the respective surface areas of the trailing step portion 56 and the trailing pad 66 must be increased to support a large load. It is not to be desired, therefore, that the pad area should be reduced in consideration of the anti-shock performance, as well as the reduced flying height and insufficient rolling rigidity.

According to the present embodiment, the surface area of the upper surface of the trailing pad 66 of the slider 42 is 1.5% or more, preferably from 2 to 5%, of the entire surface area of the disk facing surface 43.

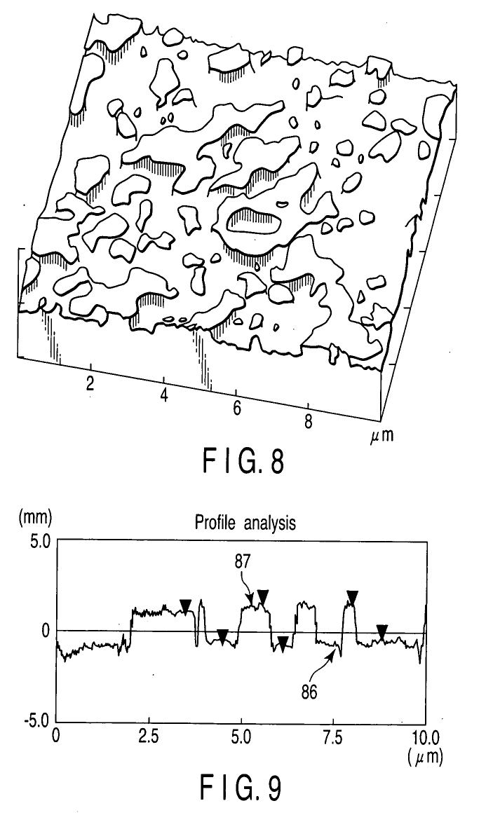

Accordingly, it is important to reduce the contact area without greatly changing the generated pressure. To attain this, indentations are formed by utilizing the difference in etching rate between Al and TiC that constitute a multicrystalline material called AlTiC, a main material of the slider 42. In general, these indentations are called microtextures. FIG. 8 shows an example in which the disk facing surface 43 of the slider 42 is microtextured by utilizing the difference in etching rate between Al and TiC. FIG. 8 shows an image observed through an atomic force microscope (AFM) with a 1 μm×1 μm visual field, and FIG. 9 shows an example of a profile based on FIG. 8. In FIG. 8, black and white parts represent Al and TiC, respectively. The area ratio of a conventional AlTiC slider is TiC:Al=3:7.

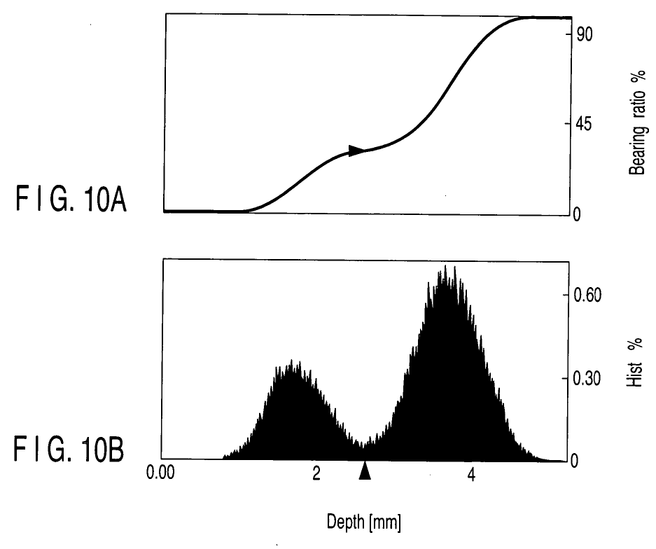

In the profile of FIG. 9, on the other hand, numerals 86 and 87 denote Al and TiC, respectively. In this example, differences in level between Al and TiC (depths of microtextures) are 2 nm or more. In the microtextures, the composition ratio (substantially equal to the area ratio) between Al and TiC in the AlTiC material is substantially settled. In order to control the attraction force, therefore, the microtexture depth must be controlled. In one method of measuring the microtexture depth, the surface of the slider 42 is determined by the AFM and evaluated with reference to its profile. According to this method, however, the depth can be measured only for a very small area. Preferably, therefore, the depth should be measured by evaluating bearing curves for the heights of the entire AFM visual field, such as the ones shown in FIGS. 10A and 10B, and measuring the interval between their two peaks. The two peaks are equivalent individually to a recess and a projection of each microtexture.

Tables 3 and 4 show the respective line speeds of HDDs with three disk diameters and results of TD/TO tests for cases where microtextures are used and not used. Table 3 shows the case where microtextures are not used, and Table 4 shows the case where microtextures are used. The smaller the disk diameter and the lower the line speed, as seen from these tables, the greater a decrement of the difference (TO−TD) between the touchdown atmospheric pressure and the takeoff atmospheric pressure with use of microtextures is.

TABLE 3

| | 2.5 | 1.8 | 0.85 |
|---|---|---|---|
| | inches | inches | inches |
| Touchdown (atm) | 0.52 | 0.53 | 0.55 |
| Takeoff (atm) | 0.68 | 0.69 | 0.95 |
| TO − TD (atm) | 0.16 | 0.16 | 0.40 |

TABLE 4

| | 2.5 | 1.8 | 0.85 |
|---|---|---|---|
| | inches | inches | inches |
| Touchdown (atm) | 0.52 | 0.53 | 0.55 |
| Takeoff (atm) | 0.65 | 0.65 | 0.70 |
| TO − TD (atm) | 0.12 | 0.12 | 0.15 |

In general, a takeoff atmospheric pressure that ensures the reliability of the magnetic disk device is about 0.7 atm., which is substantially equal to an atmospheric pressure at an altitude of 10,000 feet (3,000 m) that is guaranteed by the device. For a disk drive for a small-diameter magnetic disk of 1 inch or less, represented by a 0.85-inch disk, therefore, it is indicated that the required takeoff atmospheric pressure cannot be obtained unless microtextures are used to reduce the attraction force.

Table 5 shows results of a TD/TO test obtained when the microtexture depth was changed. There is no effect when the microtexture depth is 0.8 nm. This is because the depth of 0.8 nm is so short that the lubricant creeps up to reach recesses of the microtextures, thereby increasing the attraction area.

TABLE 5

| | 0.8 nm | 2 nm | 4 nm |
|---|---|---|---|
| Touchdown (atm) | 0.56 | 0.55 | 0.57 |
| Takeoff (atm) | 0.96 | 0.70 | 0.71 |
| TO − TD (atm) | 0.40 | 0.15 | 0.14 |

On the other hand, there is an effect if the depth of microtextures is 2 nm, and depths of 4 and 2 nm are hardly different in effect. This is supposed to be attributable to the fact that the creep of the lubricant cannot reach the recesses if the depth is 2 nm or more. Preferably, therefore, the microtexture depth should be about 2 nm based on the evaluation of the bearing curves.

According to the HDD constructed in this manner, the attraction between the slider and the disk surface can be restrained by maintaining the air bearing force of the slider under decompression and microtexturing the slider surface even with use of a small-diameter magnetic disk with a diameter of one inch or less. Thus, the head vibration under decompression can be restrained, so that a disk device with improved stability and reliability can be obtained.

The present invention is not limited directly to the embodiment described above, and its components may be embodied in modified forms without departing from the scope or spirit of the invention. Further, various inventions may be made by suitably combining a plurality of components described in connection with the foregoing embodiments. For example, some of the components according to the foregoing embodiment may be omitted. Furthermore, components according to different embodiments may be combined as required.

The shapes, dimensions, etc. of the leading step portion, trailing step portion, and pads of the slider may be variously changed as required without being limited to the foregoing embodiment. Further, the number of magnetic disks and the number of magnetic heads may be increased as required.

What is claimed is:

1. A disk device comprising:
a disk-shaped recording medium with a surface roughness of 0.8 nm or less in terms of Ra and a diameter of 1 inch or less;
a drive unit which supports and rotates the recording medium;
a head provided with a slider which has a facing surface opposed to a surface of the recording medium and is aerodynamically supported by an airflow generated between the recording medium surface and the facing surface as the recording medium rotates and a head portion which is provided on the slider and records and reproduces information to and from the recording medium; and
a head suspension which supports the head for movement with respect to the recording medium and applies to the head a head load of 1 gf or more directed toward the surface of the recording medium,
the slider having a negative-pressure cavity which is defined by a recess formed in the facing surface and generates a negative pressure, a leading step portion and a leading pad which protrude from the facing surface, are situated on the upstream side of the negative-pressure cavity with respect to the airflow, and face the recording medium, and a trailing step portion and a trailing pad which protrude from the facing surface, are situated on the downstream side of the negative-pressure cavity with respect to the airflow, and face the recording medium,
the surface area of the trailing pad accounting for 1.5% or more of the area of the disk facing surface of the slider, and at least the surface of the trailing pad being microtexured.

2. A disk device according to claim 1, wherein the depth of microtextures on the slider is 1 nm or more.

3. A disk device according to claim 1, wherein the slider has a pair of rail portions which extend from the leading step to the downstream end of the slider and protrudes from the facing surface so as to surround the negative-pressure cavity.

4. A disk device according to claim 2, wherein the slider has a pair of rail portions which extend from the leading step to the downstream end of the slider and protrudes from the facing surface so as to surround the negative-pressure cavity.
